(19) United States
(12) Patent Application Publication
(10) Pub. No.: US 2025/0019996 A1
(43) Pub. Date: Jan. 16, 2025

(54) MOTOR-DRIVEN WIND PRESSURE RESISTANT ELECTRIC LOCK STRIKE

(71) Applicant: Shenzhen YLI Electric Lock Co., Ltd., Shenzhen (CN)

(72) Inventor: Fuyu Cen, Shenzhen (CN)

(21) Appl. No.: 18/531,677

(22) Filed: Dec. 6, 2023

(30) Foreign Application Priority Data
Jul. 10, 2023 (CN) 202321805138.X

(51) Int. Cl. E05B 47/00

(52) U.S. Cl. CPC E05B 47/0047; E05B 2047/0054; E05B 2047/0067

(57) ABSTRACT

A motor-driven wind pressure resistant electric lock strike includes a lock body, the lock body being provided therein with a lock tongue, a lock block assembly, a PCB board, and a drive assembly electrically connected to the PCB board. Hall switches are integrated on both sides of the PCB board. This device replaces the traditional electromagnet drive with a speed reduction motor drive. Motor torque is more powerful than the traditional electromagnet drive. When a door opening signal is given, linking gears drive the lock block to move after the motor rotates. When the lock block is far away from one end of the lock tongue, at this time the lock tongue is in an unlocked state without obstruction. At this time, a lock tongue of a door-pushing mechanical lock pushes the lock tongue to rotate at an angle and retract into a bottom case, thereby realizing unlocking.

### CROSS REFERENCE TO RELATED APPLICATIONS

The present application claims the benefit of Chinese Patent Application No. 202321805138.X filed on Jul. 10, 2023, the contents of which are incorporated herein by reference in their entirety.

### TECHNICAL FIELD

The present disclosure belongs to the technical field of locks, and is specifically a motor-driven wind pressure resistant electric lock strike.

### BACKGROUND TECHNOLOGY

Electric lock strikes are also called cathode locks. Electric lock strikes are used with mechanical locks (such as spheroidal locks) and can be used both electrically and manually. The mechanical lock is equipped with a linking triangular latch. When a door lock is locked (a latch is pressed down), a lock tongue is caught and cannot be retracted. This is a safety design that prevents a lock case from being maliciously pried open by an external force.

At present, most electric lock strikes on the market use electromagnets to generate magnetic force and drive a lock block to move so as to achieve locking. After power failure, a reset compression spring is used to reset and achieve unlocking. When this type of electric lock strike is maintained in the locked or unlocked state, the electromagnet often needs to be continuously energized. It consumes more power and generates heat easily. In addition, most of the internal mechanical motion is largely linkage motion. There are many moving components and the requirement of accuracy of processing each moving component is very high. At the same time, the electromagnet is also greatly affected by voltage and current during operation, and the overall stability is not good.

### SUMMARY OF THE DISCLOSURE

In order to overcome the shortcomings of the prior art, an object of the present disclosure is to provide a motor-driven wind pressure resistant electric lock strike.

The technical solution adopted by the present disclosure is as follows: a motor-driven wind pressure resistant electric lock strike, including a lock body, the lock body being provided therein with a lock tongue, a lock block assembly, a PCB board, and a drive assembly electrically connected with the PCB board, wherein Hall switches are integrated on both sides of the PCB board; an output end of the drive assembly is fixedly connected with a transmission gear, one end of the transmission gear is in meshing connection with a linking gear, upper and lower sides of the linking gear are provided with gear teeth, the lock block assembly is provided with a linking rack located at one end and on front and rear sides of the linking gear, the linking rack is meshed with the gear teeth on the lower side of the linking gear for driving the lock block assembly to move back and forth; when the lock block assembly moves below one end of the lock tongue, an upper wall of the lock block assembly abuts against an inner wall of the lock tongue, and a locked state is entered.

In a preferred embodiment, the lock block assembly is further embedded with a magnet, when the lock block assembly moves from one end to another end, the magnet senses positions of the Hall switches on both sides of the PCB board, If the magnet senses any one of the Hall switches, the drive assembly stops operating.

In a preferred embodiment, an extended end of the lock tongue is an arc-shaped inclining face, two sides of an opposite end of the lock tongue are connected to a lock tongue connecting shaft, two ends of the lock tongue connecting shaft are rotatably coupled to the lock body.

In a preferred embodiment, the lock tongue connecting shaft is further provided with a signal bar, a lock tongue torsion spring and a signal bar torsion spring, the lock tongue torsion spring is sleeved on the lock tongue connecting shaft, the signal bar is rotatably mounted on the lock tongue connecting shaft, one end of the signal bar is provided with an opening, the signal bar torsion spring is sleeved on the lock tongue connecting shaft at an inner side of the opening of the signal bar.

In a preferred embodiment, a micro switch is provided in the lock body, two ends of the signal bar are both integrally formed with a protrusion, when the signal bar is pressed down by a force, the protrusion at one end of the signal bar and the micro switch are in contact with each other.

In a preferred embodiment, the linking gear is rotatably mounted inside the lock body, a guide rail is provided in the lock body, the lock block assembly is slidably mounted on the guide rail.

In a preferred embodiment, a cover plate and a mounting panel are further provided on the lock body, the cover plate is provided therethrough with a cavity that is sufficient for the protrusion on a left side of the signal bar to pass through, a lock opening is formed between the lock body, the cover plate, and the lock tongue.

In a preferred embodiment, the lock body is fixedly mounted in a door frame, a mechanical lock is mounted in a corresponding door body on one side oppositely facing the lock body, and a lock tongue of the mechanical lock corresponds to the lock opening, and is embeddable in the lock opening.

In a preferred embodiment, one end of the lock body is further connected with a multi-strand wire.

In a preferred embodiment, the drive assembly is a speed reduction motor.

In summary, due to the adoption of the above technical solution, the beneficial effects of the present disclosure are:

the traditional electromagnet drive is replaced with a speed reduction motor drive. The motor torque is more powerful than the traditional electromagnet drive. When a door opening signal is given, the linking gear drives the lock block to move after the motor rotates. When the lock block is far away from one end of the lock tongue, at this time the lock tongue is in an unlocked state without obstruction. When the door is pushed at this time, the lock tongue of the mechanical lock pushes the lock tongue to rotate at an angle and retract into a bottom case to realize unlocking. The mechanical structure will not get stuck due to pressing by external forces. The door can be opened normally. Secondly, after entering the locking and unlocking state, there is no need for continuous power supply and less power is consumed. Moreover, since there is no need to keep the power on all the time, the entire body does not heat up easily and the overall safety of use is ensured. At the same time, distance can be set and position can be controlled precisely through a logic program and precision electronic components for locking and unlocking, and the performance is more stable.

### DESCRIPTION OF THE DRAWINGS

FIG. 1 is a schematic diagram of a three-dimensional structure of the entire electric lock strike;

FIG. 2 is a schematic diagram of an exploded three-dimensional structure of the entire electric lock strike;

FIG. 3 is a schematic diagram of a three-dimensional structure of the lock tongue control portion in the lock body of the electric lock strike;

FIG. 4 is a schematic cross-sectional plan view of the lock body in the unlocked and locked states of the electric lock strike;

FIG. 5 is a schematic diagram of an enlarged three-dimensional structure at A in FIG. 4;

FIG. 6 is a schematic diagram of an enlarged three-dimensional structure at B in FIG. 4;

FIG. 7 is a schematic plan view of the structure of the electric lock strike and the mechanical lock assembled on a door;

FIG. 8 is a schematic diagram of a three-dimensional structure of the linking gear of the electric lock strike.

Symbols in the figures: 1—Multi-strand wire, 2—Mounting panel, 3—Lock tongue, 4—Lock body, 5—Cover plate, 6—Micro switch, 7—Drive assembly, 8—PCB board, 9—Magnet, 10—Lock block assembly, 11—Signal bar torsion spring, 12—Linking gear, 13—Transmission gear, 14—Linking rack, 15—Lock tongue connecting shaft, 16—Lock tongue torsion spring, 17—Signal bar, 18—Hall switch.

### SPECIFIC EMBODIMENTS

The disclosure will be further described in detail below with reference to the embodiments and the accompanying drawings.

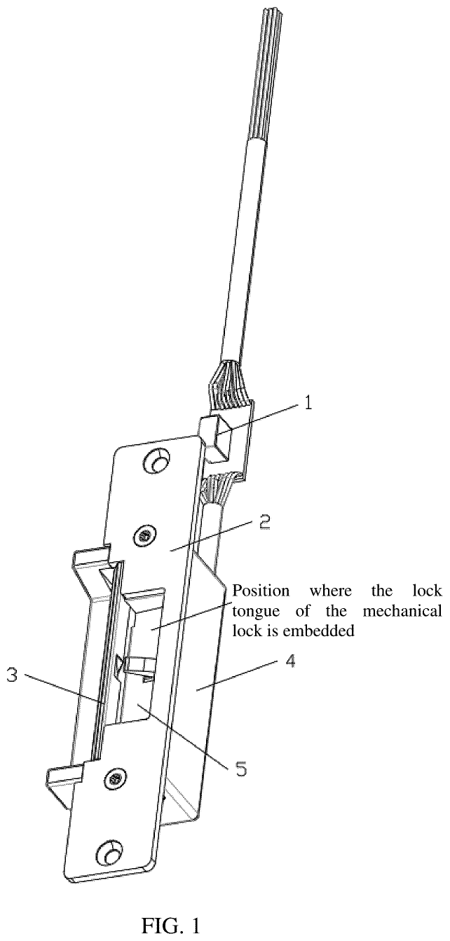

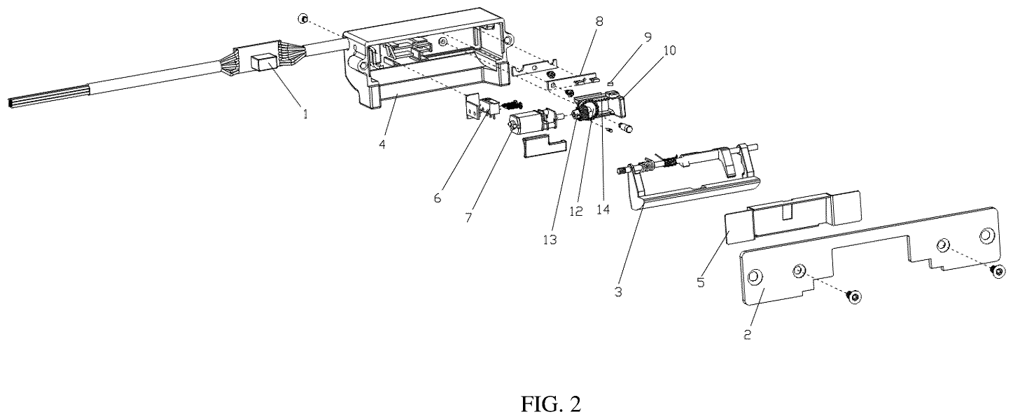

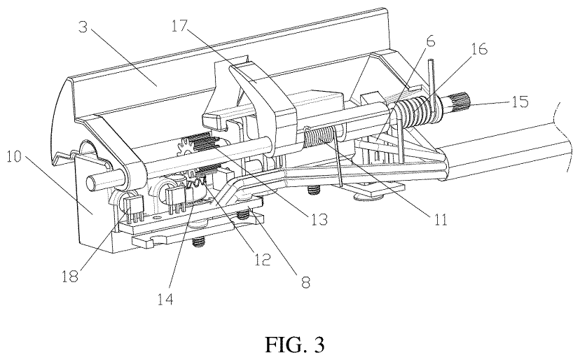

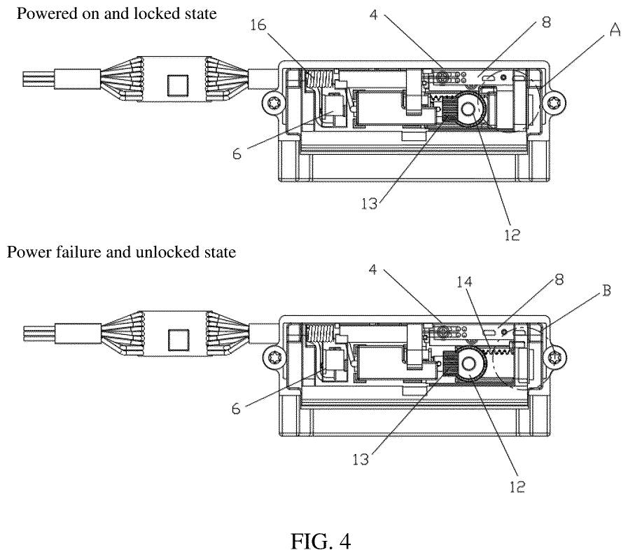

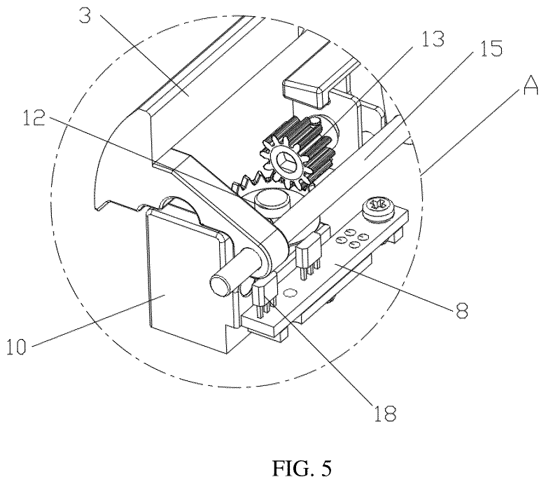

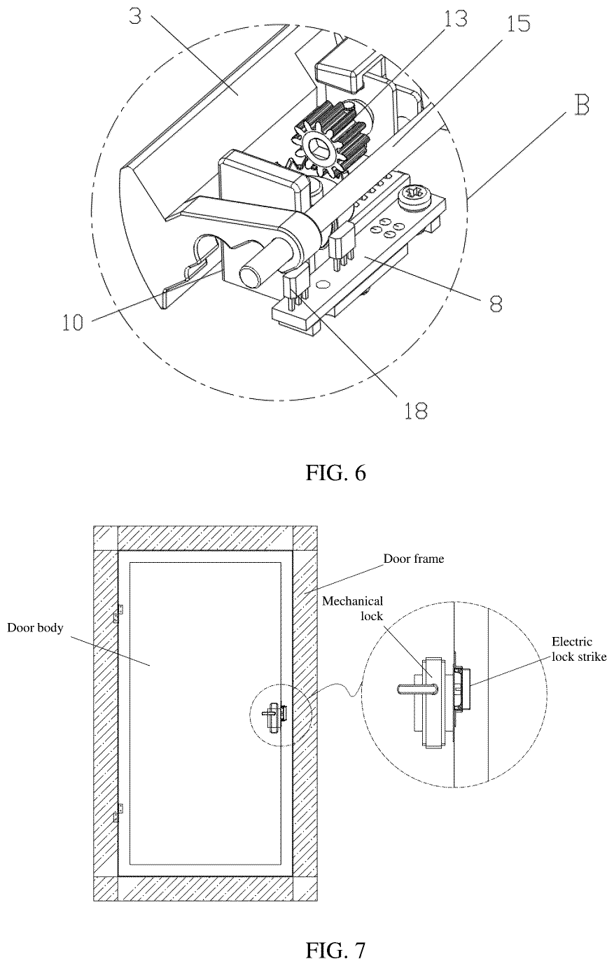

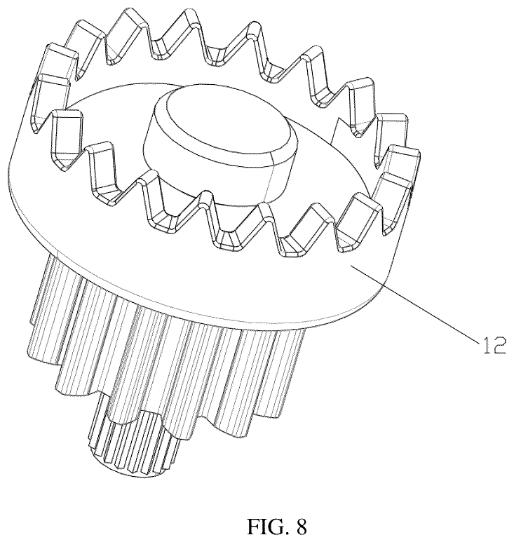

Referring to FIGS. 1-8, a motor-driven wind pressure resistant electric lock strike includes a lock body 4, and the lock body 4 is provided therein with a lock tongue 3, a lock block assembly 10, a PCB board 8, and a drive assembly 7 electrically connected with the PCB board 8. An output end of the drive assembly 7 is fixedly connected with a transmission gear 13. One end of the transmission gear 13 is in meshing connection with a linking gear 12, and the upper and lower sides of the linking gear 12 are provided with gear teeth. The lock block assembly 10 is provided with a linking rack 14 located at one end and on front and rear sides of the linking gear 12. The linking rack 14 is meshed with the gear teeth on the lower side of the linking gear 12 for driving the lock block assembly 10 to move back and forth. When the lock block assembly 10 moves below one end of the lock tongue 3, an upper wall of the lock block assembly 10 abuts against an inner wall of the lock tongue 3, and a locked state is entered. The traditional electromagnet drive is replaced with a speed reduction motor drive. The motor torque is more powerful than the traditional electromagnet drive. The mechanical structure will not get stuck due to pressing by an external force. The door can be opened normally.

When a door opening signal is given, the output end of the drive assembly 7 drives the transmission gear 13 to rotate, and the transmission gear 13 drives the linking gear 12 to rotate. During rotation of the linking gear 12, the meshing linking rack 14 is driven to move, thereby achieving back and forth movement of the lock block assembly 10. When the lock block assembly 10 is far away from one end of the lock tongue 3, at this time the lock tongue 3 is in an unlocked state without obstruction. At this time, when the door is pushed, a lock tongue of a mechanical lock pushes the lock tongue 3 to rotate at an angle and retract into the lock body 4 to realize the unlocking operation.

When entering the locked state, since the upper wall of the lock block assembly 10 abuts against the inner wall of the lock tongue 3, the lock tongue 3 cannot rotate downwards at this time. When the door is closed, the lock tongue of the mechanical lock is embedded in a lock opening of the electric lock strike so as to realize the locking operation. After the electric lock strike enters the locked and unlocked state, there is no need for continuous power supply so that less power is consumed. Moreover, since it does not need to be powered on all the time, the entire body does not heat up easily and the overall safety of use can be ensured.

It should be noted that the drive assembly 7 is a speed reduction motor, which is used to realize rotation operation of the transmission gear 13.

In the present embodiment, Hall switches 18 are integrated on both sides of the PCB board 8. A magnet 9 is further embedded in the lock block assembly 10. The magnet 9 senses the position of the Hall switches 18 on both sides of the PCB board 8 when the lock block assembly 10 moves from one end to the other end. If the magnet 9 senses any one of the Hall switches 18, then the drive assembly 7 stops operating. During the process of back-and-forth motion of the lock block assembly 10, the position of the lock block assembly 10 can be sensed through the cooperation of the Hall switches 18 and the magnet 9. This can realize precise setting of distance and control of the position of the lock block assembly 10.

Among them, two Hall switches 18 are correspondingly arranged directly above a moving path of the magnet 9. This can sense the magnet 9 in a timely and effective manner, thereby having an accurate position of the lock block assembly 10.

In addition, the PCB board 8 includes a microcomputer control program. An electronic dual in-line package switch component is welded on the PCB board 8, which can set a locking delay time. The locking delay is preferably set to a fixed 5 seconds, and the locking action will be automatically repeated after 5 seconds. The PCB board 8 is also electrically connected to a peripheral control terminal (not shown in the figure).

In the present embodiment, an extended end of the lock tongue 3 is an arc-shaped inclining face, and two sides of an opposite end are connected to a lock tongue connecting shaft 15. Two ends of the lock tongue connecting shaft 15 are rotatably coupled to the lock body 4. When closing the door, a lock tongue of a mechanical lock retracts into the mechanical lock when it comes into contact with the arc-shaped inclining face. When the lock tongue of the mechanical lock is located at the lock opening after retraction, since there is no supporting force from the arc-shaped inclining face, the tongue of the mechanical lock resets and embeds into the lock opening to complete the locking operation.

In the present embodiment, the lock tongue connecting shaft 15 is further provided with a signal bar 17, a lock tongue torsion spring 16 and a signal bar torsion spring 11. The lock tongue torsion spring 16 is sleeved on the lock tongue connecting shaft 15. The signal bar 17 is rotatably mounted on the lock tongue connecting shaft 15. One end of the signal bar 17 is provided with an opening, and the signal bar torsion spring 11 is sleeved on the lock tongue connecting shaft 15 on an inner side of the opening of the signal bar 17. The lock tongue torsion spring 16 and the signal bar torsion spring 11 are respectively used to reset the lock tongue connecting shaft 15 and the signal bar 17 (that is, they are reset by a torsion spring rebound force after not being pressed).

In the present embodiment, a micro switch 6 is provided in the lock body 4. Two ends of the signal bar 17 are integrally formed with a protrusion. When the signal bar 17 is pressed down by force, the protrusion at one end of the signal bar 17 and the micro switch 6 are in contact with each other. When the door is closed and locked, the lock tongue of the mechanical lock presses the protrusion at one end of the signal bar 17, and the protrusion touches the micro switch 6 so that a door status signal can be transmitted to a control terminal.

In the present embodiment, the linking gear 12 is rotatably mounted inside the lock body 4. A guide rail is provided in the lock body 4. The lock block assembly 10 can be slidably mounted on the guide rail. The guide rail provided can have an auxiliary guiding function to facilitate movement of the lock block assembly 10 and ensure the stability of the movement of the lock block assembly 10. In this embodiment, one end of the lock body 4 is further connected with a multi-strand wire 1. The wire 1 includes a power supply wire, an electronically controlled lock-opening wire, a door signal wire, and a lock signal wire. The power supply wire is: red positive pole and black negative pole.

Among them, the door signal wire is: white (common terminal), green NO (Normally Open); the lock signal wire is: brown NC (Normally Closed), blue NO (Normally Open), yellow COM (Common terminal).

In the present embodiment, a cover plate 5 and a mounting panel 2 are further provided on the lock body 4. The cover plate 5 is provided therethrough with a cavity that is sufficient for the protrusion on a left side of the signal bar 17 to pass through. A lock opening is formed between the lock body 4, the cover plate 5 and the lock tongue 3. The lock body 4 is fixedly installed in a door frame. The mechanical lock is mounted in a corresponding door body on one side oppositely facing the lock body 4. The lock tongue of the mechanical lock corresponds to the lock opening, and is embeddable in the lock opening. After the door is closed, the lock tongue of the mechanical lock is embedded in the electric lock strike. At this time, the electric lock strike remains at a locked state to realize locking operation.

It should be noted that the lock body 4, mounting panel 2, cover plate 5 and lock tongue 3 may be made of 304 stainless steel. The lock tongue may be made of 304 stainless steel. The internal transmission parts are all metal parts, making the whole lock strong and firm. The tolerable impact force is 500 KG.

At this time, it should be mentioned that the electrical connection methods mentioned above are all connection methods commonly used in the prior art, and details will not be described again.

The present device replaces the traditional electromagnet drive with a speed reduction motor drive. The motor torque is more powerful than the traditional electromagnet drive. When a door opening signal is given, the output end of the drive assembly 7 drives the transmission gear 13 to rotate, and the transmission gear 13 drives the linking gear 12 to rotates. During rotation of the linking gear 12, the meshing linking rack 14 is driven to move. When the lock block assembly 10 is far away from one end of the lock tongue 3, at this time the lock tongue 3 is in an unlocked state without obstruction. At this time, when the door is pushed, the lock tongue of the mechanical lock pushes the lock tongue 3 to rotate at an angle and retract into the lock body 4 so as to realize unlocking. The mechanical structure will not get stuck due to pressing by an external force. The door can be opened normally.

In addition, there is no need for continuous power supply after entering the locked and unlocked state, so that less power is consumed. Moreover, since there is no need to keep the power on all the time, the entire body does not heat up easily and the overall safety of use is ensured. Furthermore, distance can be set and position can be controlled precisely through a logic program and precision electronic components for locking and unlocking, and performance is more stable.

The above descriptions are only preferred embodiments of the present disclosure and are not intended to limit the present disclosure. Any modifications, equivalent substitutions and improvements made within the spirit and principle of the present disclosure shall be included in the scope of protection of the present disclosure.

What is claimed is:

1. A motor-driven wind pressure resistant electric lock strike, comprising a lock body, the lock body being provided therein with a lock tongue, a lock block assembly, a PCB board, and a drive assembly electrically connected with the PCB board, wherein:
Hall switches are integrated on both sides of the PCB board;
an output end of the drive assembly is fixedly connected with a transmission gear, one end of the transmission gear is in meshing connection with a linking gear, upper and lower sides of the linking gear are provided with gear teeth, the lock block assembly is provided with a linking rack located at one end and on front and rear sides of the linking gear, the linking rack is meshed with the gear teeth on the lower side of the linking gear for driving the lock block assembly to move back and forth;
when the lock block assembly moves below one end of the lock tongue, an upper wall of the lock block assembly abuts against an inner wall of the lock tongue, and a locked state is entered.

2. The motor-driven wind pressure resistant electric lock strike according to claim 1, wherein the lock block assembly is further embedded with a magnet, when the lock block assembly moves from one end to another end, the magnet senses positions of the Hall switches on both sides of the PCB board, If the magnet senses any one of the Hall switches, the drive assembly stops operating.

3. The motor-driven wind pressure resistant electric lock strike according to claim 1, wherein an extended end of the lock tongue is an arc-shaped inclining face, two sides of an opposite end of the lock tongue are connected to a lock tongue connecting shaft, two ends of the lock tongue connecting shaft are rotatably coupled to the lock body.

4. The motor-driven wind pressure resistant electric lock strike according to claim 3, wherein the lock tongue connecting shaft is further provided with a signal bar, a lock tongue torsion spring and a signal bar torsion spring, the lock tongue torsion spring is sleeved on the lock tongue connecting shaft, the signal bar is rotatably mounted on the lock tongue connecting shaft, one end of the signal bar is provided with an opening, the signal bar torsion spring is sleeved on the lock tongue connecting shaft at an inner side of the opening of the signal bar.

5. The motor-driven wind pressure resistant electric lock strike according to claim 4, wherein a micro switch is provided in the lock body, two ends of the signal bar are both integrally formed with a protrusion, when the signal bar is pressed down by a force, the protrusion at one end of the signal bar and the micro switch are in contact with each other.

6. The motor-driven wind pressure resistant electric lock strike according to claim 1, wherein the linking gear is rotatably mounted inside the lock body, a guide rail is provided in the lock body, the lock block assembly is slidably mounted on the guide rail.

7. The motor-driven wind pressure resistant electric lock strike according to claim 5, wherein a cover plate and a mounting panel are further provided on the lock body, the cover plate is provided therethrough with a cavity that is sufficient for the protrusion on a left side of the signal bar to pass through, a lock opening is formed between the lock body, the cover plate, and the lock tongue.

8. The motor-driven wind pressure resistant electric lock strike according to claim 7, wherein the lock body is fixedly mounted in a door frame, a mechanical lock is mounted in a corresponding door body on one side oppositely facing the lock body, and a lock tongue of the mechanical lock corresponds to the lock opening, and is embeddable in the lock opening.

9. The motor-driven wind pressure resistant electric lock strike according to claim 1, wherein one end of the lock body is further connected with a multi-strand wire.

10. The motor-driven wind pressure resistant electric lock strike according to claim 1, wherein the drive assembly is a speed reduction motor.
